(19) United States
(12) Patent Application Publication
(10) Pub. No.: US 2015/0127654 A1
(43) Pub. Date: May 7, 2015

(54) METHOD FOR MANAGING USER INFORMATION AND ELECTRONIC DEVICE THEREOF

(71) Applicant: Samsung Electronics Co., Ltd., Gyeonggi-do (KR)

(72) Inventors: Seung-Eun LEE, Seoul (KR); Sun-Min HWANG, Gyeonggi-do (KR); Hyung-Suk HWANG, Gyeonggi-do (KR)

(21) Appl. No.: 14/535,463

(22) Filed: Nov. 7, 2014

(30) Foreign Application Priority Data
Nov. 7, 2013 (KR) 10-2013-0135029

(51) Int. Cl. G06F 17/30

(52) U.S. Cl. CPC G06F 17/30707
USPC 707/740

(57) ABSTRACT

An apparatus and method for storing and displaying user information in an electronic device is provided to categorize information and designate importance. The method includes identifying a plurality of user information, extracting overlapped common information from the plurality of user information, and storing information which is not overlapped among the plurality of user information to be included in a first category and storing the common information to be included in a second category.

### CLAIM OF PRIORITY

This application claims the benefit of priority under 35 U.S.C. §119(a) from a Korean patent application filed in the Korean Intellectual Property Office on Nov. 7, 2013 and assigned Serial No. 10-2013-0135029, the entire disclosure of which is hereby incorporated by reference in its entirety.

### BACKGROUND

1. Technical Field

The present disclosure relates to a method for managing user information and an electronic device thereof.

2. Description of the Related Art

As information and communication technologies and semiconductor technologies have been developed, each of the various electronic devices that have been developed may provide multimedia services, such as a voice call service, a video call service, a messenger service, a broadcasting service, a wireless Internet service, a camera service, and a music play service.

Such electronic devices may have a phonebook service for storing important phone numbers and information (e.g., names, jobs, departments, photos, emails, other phone numbers, addresses, anniversaries, groups, etc.) related to the phone numbers in business or privacy of its user and performing a linked function for the corresponding phone number through a search of the user.

There is an inconvenience in that the user of the electronic device must classify and input information related to phone numbers separately as it is being classified according to categories to classify, and then store the information related to the phone numbers as it is being classified according to categories.

Also, when a length of a record related to a phone number exceeds a length of a display region which displays user information, the electronic device does not display a part (e.g. cuts off for display) of the information related to the phone number.

### SUMMARY

An aspect of the present disclosure is to solve at least some of the above-mentioned problems and/or disadvantages and to provide at least the advantages described below.

Accordingly, an aspect of the present disclosure is to provide an apparatus and method for efficiently storing user information in an electronic device.

Accordingly, another aspect of the present disclosure is to provide an apparatus and method for classifying and storing user information in an electronic device while being classified according to categories.

Accordingly, another aspect of the present disclosure is to provide an apparatus and method for classifying and storing user information in an electronic device while being classified into categories according to category classification information included in the user information.

Accordingly, another aspect of the present disclosure is to provide an apparatus and method for extracting common information included in user information, and classifying and storing the user information in an electronic device while being classified according to categories.

Accordingly, another aspect of the present disclosure is to provide an apparatus and method for efficiently displaying user information in an electronic device.

Accordingly, another aspect of the present disclosure is to provide an apparatus and method for contracting and displaying common information included in user information in an electronic device.

Accordingly, another aspect of the present disclosure is to provide an apparatus and method for displaying some category information included in user information as a symbol in an electronic device.

In accordance with an aspect of the present disclosure, a method of storing user information in an electronic device is provided. The method includes identifying a plurality of user information, extracting common information from the plurality of user information, and storing common information of the plurality of user information in a first category, and storing another information except the common information among the plurality of user information in a second category.

In accordance with another aspect of the present disclosure, an electronic device is provided. The electronic device includes a memory and a processor, wherein the processor extracts common information from the plurality of user information and storing the common information of the plurality of user information in a first category and storing another information except the common information among the plurality of user information in a second category.

### BRIEF DESCRIPTION OF THE DRAWINGS

The above and other aspects, features and advantages of certain exemplary embodiments of the present disclosure will become more apparent to the person of ordinary skill in the art from the following detailed description taken in conjunction with the accompanying drawings, in which:

FIG. 1 is a block diagram illustrating one possible configuration of an electronic device according to one embodiment of the present disclosure;

FIG. 2 is a block diagram illustrating detailed configuration of a processor according to one embodiment of the present disclosure;

FIG. 3 is a flowchart illustrating a process of classifying user information into a plurality of categories based on category classification information in an electronic device according to one embodiment of the present disclosure;

FIG. 4 is a flowchart illustrating a process of classifying user information into a plurality of categories based on category classification information in an electronic device according to another embodiment of the present disclosure;

FIG. 5A and FIG. 5B are screens illustrating a process of classifying user information into a plurality of categories based on category classification information in an electronic device according to one embodiment of the present disclosure;

FIG. 6A and FIG. 6B are screens illustrating a process of determining a category of user information in an electronic device according to one embodiment of the present disclosure;

FIG. 7 is a flowchart illustrating a process of classifying user information into a plurality of categories using common information included in the user information in an electronic device according to one embodiment of the present disclosure;

FIG. 8 is a flowchart illustrating a process of classifying user information into a plurality of categories using common information included in the user information in an electronic device according to another embodiment of the present disclosure;

FIG. 9 is a flowchart illustrating a process of updating a category of user information using common information of the user information in an electronic device according to one embodiment of the present disclosure;

FIG. 10 is a flowchart illustrating a process of displaying user information included in some categories as symbols in an electronic device according to one embodiment of the present disclosure;

FIG. 11 is a screen illustrating a process of displaying user information included in some categories as symbols in an electronic device according to one embodiment of the present disclosure;

FIG. 12 is a flowchart illustrating a process of contracting and displaying common information included in user information in an electronic device according to one embodiment of the present disclosure; and

FIG. 13A, FIG. 13B, FIG. 13C, FIG. 13D and FIG. 13E are screens illustrating a process of contracting and displaying common information included in user information in an electronic device according to one embodiment of the present disclosure.

### DETAILED DESCRIPTION

Exemplary embodiments of the present disclosure will be described herein below with reference to the accompanying drawings. In the following description, well-known functions or constructions may not described in detail when their inclusion would obscure the disclosure with unnecessary detail about that which is well-known.

Hereinafter, a description will be given for an apparatus and method for managing user information in an electronic device. With regard to the description, the user information may include phone numbers and information related to the phone numbers, such as names, jobs, departments, positions, photos, emails, other phone numbers, addresses, anniversaries, and groups.

Hereinafter, the electronic device according to one embodiment of the present disclosure may be applicable to one or more of various devices, such as a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), Moving Picture Experts Group (MPEG) audio layer 3 (MP3) player, accessories, electronic Appcessories, a camera, a wearable device, a wristwatch, a refrigerator, an air conditioner, a cleaner, a cybot, a TeleVision (TV), a Digital Versatile Disc (DVD) player, an audio, an oven, a microwave oven, a washing machine, an electronic bracelet, an electronic necklace, an air cleaner, an electronic picture frame, a medical device, a navigation device, a satellite signal receiver, an Event Data Recorder (EDR), a Flight Data Recorder (FDR), a set-top box, a TV box, an electronic dictionary, a car infotainment device, electronic equipment for ship, avionics, a security device, electronic clothes, an electronic key, a camcorder, a game console, a Head Mounted Display (HMD), a flat panel display, an electronic album, a part of furniture or a building/structure including an electronic device, an electronic board, an electronic signature receiving device, and a projector, just to name a few non-limiting possibilities. Also, a person skilled in the art would understand that the electronic device according to one embodiment of the present disclosure is not limited to the above-described devices.

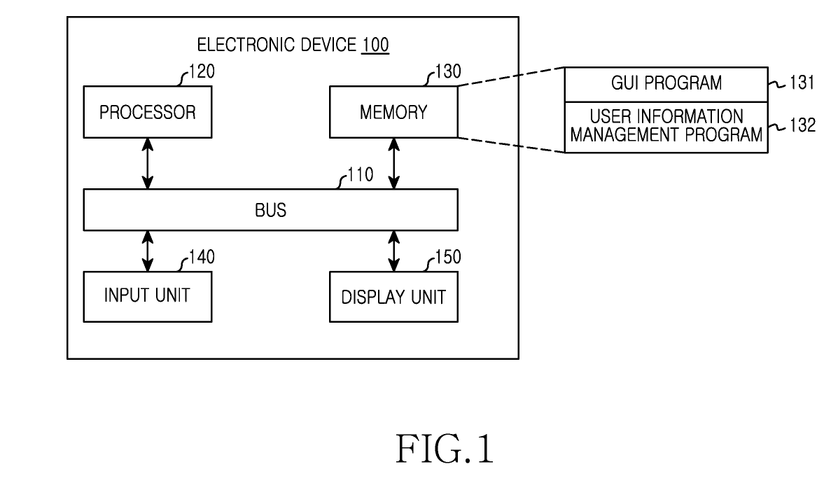

FIG. 1 is a block diagram illustrating configuration of an electronic device according to one embodiment of the present disclosure.

Referring now to FIG. 1, the electronic device denoted by 100 may include a bus 110, a processor 120, a memory 130, an input unit 140, and a display unit 150. Herein, one or more of the processor 120 and the memory 130 may be a plurality of processors and memories, respectively.

The bus 110 may connect the components included in the electronic device 100 with each other and control communication between the components included in the electronic device 100.

For example, the processor 120, which comprises hardware circuitry and may also be referred to as a microprocessor, integrated circuit, or controller may be configured to perform a control operation to provide various services in the electronic device 100. For example, the processor 120 may decode commands received from the one or more other components (e.g., the memory 130, the input unit 140, and the display unit 150) included in the electronic device 100 through the bus 110 and perform calculation or data processing corresponding to the decoded commands.

The processor 120 may perform, for example, a control operation to execute one or more programs stored in the memory 130 and provide various services in the electronic device 100. The processor 120 may execute a user information management program 132 stored in the memory 130, divide user information while being classified according to categories, and store the divided user information in the memory 130. For example, the processor 120 may divide and store the user information while being classified according to categories based on category classification information included in the user information. Herein, the category classification information may include one or more of a space symbol and other symbols (e.g., “/”, “@”, and “#”). In another example, the processor 120 may divide and store user information as candidates for storage to be newly stored while being classified according to categories based on overlapped common information between user information previously stored in the memory 130 and the user information that is to be newly stored. In another example, the processor 120 may divide and store user information while being classified according to categories based on overlapped common information among user information to be stored.

The processor 120 may control the display unit 150 to execute a Graphic User Interface (GUI) program 131 stored in the memory 130 and display user information stored in the memory 130. For example, the processor 120 may control the display unit 150 to display some information stored in a specific category as symbols from among user information that has been divided and stored while being classified into categories in the memory 130. Herein, the symbols include a logo. In another example, the processor 120 may control the display unit and display common information of user information divided and stored while being classified according to categories in the memory 130. Herein, the ion method may include, for example, one or more of a method of displaying common information by a slide type, a method of reducing and displaying a letter size of common information, a method of changing a display position of common information, and a method of changing a color of common information.

The memory 130 stores commands or data which are received from the one or more components of the electronic device (e.g., the processor 120, the input unit 140, and the display unit 150) included in the electronic device 100 or are generated by the one or more components. For example, the memory 130 may store one or more files of user information.

The memory 130 may store, for example one or more programs for services of the electronic device 100. Moreover, the memory 130 may include one or more of the Graphic User Interface (GUI) program 131 and the user information program 132.

The GUI program 131 may include at least one software component that when executed will provide a user interface as graphics on the display unit 150. For example, the GUI program 131 may control the display unit 150 to display some information stored in a specific category as symbols among user information divided and stored while being classified according to categories in the memory 130. In another example, the GUI program 131 may control the display unit 150 to contract and display common information of user information divided and stored while being classified according to categories in the memory 130.

The user information management program 132 may include at least one software component that when executed will divide user information while being classified according to categories and storing the divided user information in memory 130. For example, the user information management program 132 may divide user information while being classified into categories based on category classification information included in the user information and also store the divided user information in the memory 130. In another example, the user information management program 132 may divide user information and candidates for storage to be newly stored as the divided user information while being classified according to categories based on overlapped common information between user information stored in the memory 130 and the user information to be newly stored and store the divided user information in the memory 130. In still another example, the user information management program 132 may divide user information while being classified according to categories based on overlapped common information among user information to be stored and store the divided user information in the memory 130.

The input unit 140 may transmit commands or data generated by selection of the user to the processor 120 or the memory 130 through the bus 110. For example, the input unit 140 may include one or more of a keypad including at least one hardware button and a touch panel for sensing touch information. Alternatively, the input unit 140 could be a touch panel and could even be part of the display unit, or provide a secondary display.

The display unit 150 displays videos, images, or data to the user. For example, the display unit 150 may display information of an application program executed by the processor 130.

Although it is not shown in FIG. 1, the electronic device 100 may further include a communication module for performing communication with one or more other electronic devices, a server, or one or more peripherals. For example, the communication module may support one or more of local-area communication protocols (e.g., Wireless-Fidelity (Wi-Fi), BlueTooth (BT), Near Field Communication (NFC)) and network communication (e.g., the Internet, a Local Area Network (LAN), a Wide Area Network (WAN), a telecommunication network, a cellular network, a satellite network, and a Plain Old Telephone Service (POTS)), and could also include RF capability such as a transmitter receiver, or transceiver.

In the above-described embodiment of the present disclosure, the processor 120 may execute software components stored in the memory 130 in one module that are loaded in the processor for execution, divide user information while being classified according to categories, and store the divided user information in the memory 130. Also, the processor 120 may display user information stored in the memory 130 on the display unit 150.

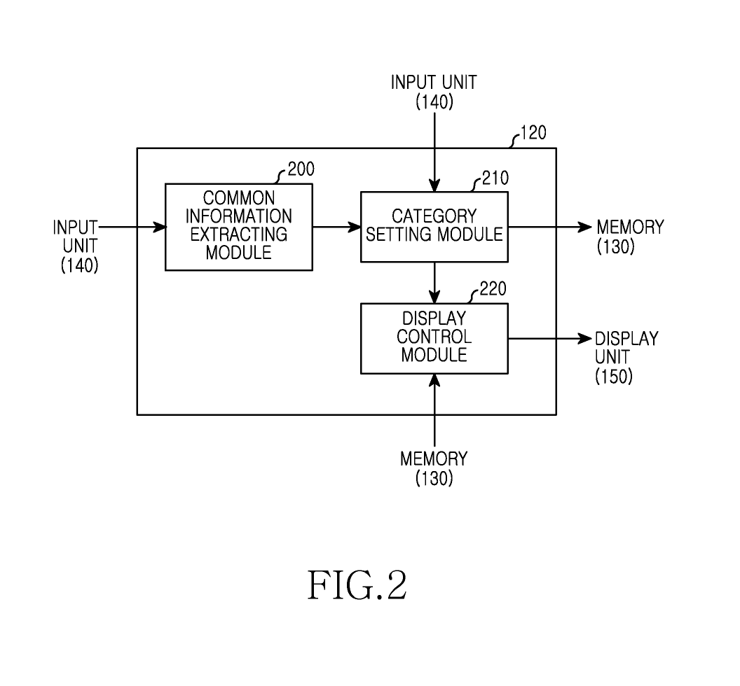

In another embodiment of the present disclosure, the processor 120 may include, as shown in FIG. 2, components used for dividing user information being classified according to categories, storing the divided user information in the memory 130, and displaying the user information stored in the memory 130 on the display unit 150 as separate modules.

FIG. 2 is a block diagram illustrating detailed configuration of a processor according to one embodiment of the present disclosure.

Referring now to FIGS. 1 and 2, the processor 120 may include a common information extracting module 200, a category setting module 210, and a display control module 220. These modules may include machine executable code that loaded into the processor for execution. The modules may also be sub-processors loaded with machine executable code.

In more detail, the common information extracting module 200 may extract overlapped common information from user information. Herein, the common information extracting module 200 may execute the user information management program 132 stored in the memory 130 and extract overlapped common information from user information. For example, the common information extracting module 200 may extract common information overlapped between user information stored in the memory 130 and user information to be newly stored. In another example, the common information extracting module 200 may extract overlapped common information from user information to be stored in the memory 130.

With continued reference to FIG. 2, the category setting module 210 may divide user information to be stored in the memory 130 while being classified according to categories. Herein, the category setting module 210 may execute the user information management program 132 stored in the memory 130 and divide user information to be stored in the memory 130 while being classified according to categories. For example, the category setting module 210 may divide user information based on category classification information and a category setting order included in the user information while being classified according to categories. In more detail, when user information of “Hong Gildong/Samsung Electronics/development group/assistant manager” is received through the input unit 140, the category setting module 210 may divide the user information to include the “HongGildong” in a basic category (a name category), include the “SamsungElectronics” in a “job” category having a second priority, include the “developmentgroup” in a “department” category having a third priority, and include the “assistantmanager” in a “position” category having a fourth priority according to category classification information and a category setting order. Herein, the category setting order may be changed by a user of the electronic device 100.

In another example, the category setting module 210 may divide user information as it is being classified according to categories based on common information extracted in the common information extracting module 200 and a category setting order.

In more detail, when user information of “SamsungElectronicsdevelopmentgroup” of the “SamsungElectronicsdevelopmentgroupHongGildongassistantmanager” is common information which is overlapped with user information stored in the memory 130, the category setting module 210 may divide user information to include user information of the “HongGildongassistantmanager” which are not overlapped in a basic category and include user information of the “SamsungElectronicsdevelopmentgroup” in a “job” category having a next priority.

The display control module 220 may control the display unit 150 to provide a user interface as graphics displayed on the display unit 150. Herein, the display control module 220 may control the display unit 150 to execute the GUI program 131 stored in the memory 130 and provide a user interface as graphics on the display unit 150. For example, the display control module 220 may control the display unit 150 to display user information stored in a specific category (e.g., a “job” category) as symbols among user information divided and stored while being classified according to categories in the memory 130. In another example, the display control module 220 may control the display unit 150 to contract and display common information of user information divided and stored while being classified according to categories in the memory 130. Herein, a contraction method may include one or more of a method of displaying common information by a slide type, a method of reducing and displaying a letter size of common information, a method of changing a display position of common information, and a method of changing a color of common information.

In the above-described embodiment of the present disclosure, the electronic device 100 may divide user information while being classified according to categories, store the divided user information in the memory 130 using the processor 120, and display the user information stored in the memory 130 on the display unit 150.

In another embodiment of the present disclosure, the electronic device 100 may include a separate control module for dividing user information while being classified according to categories, storing the divided user information in the memory 130, and displaying the user information stored in the memory 130 on the display unit 150.

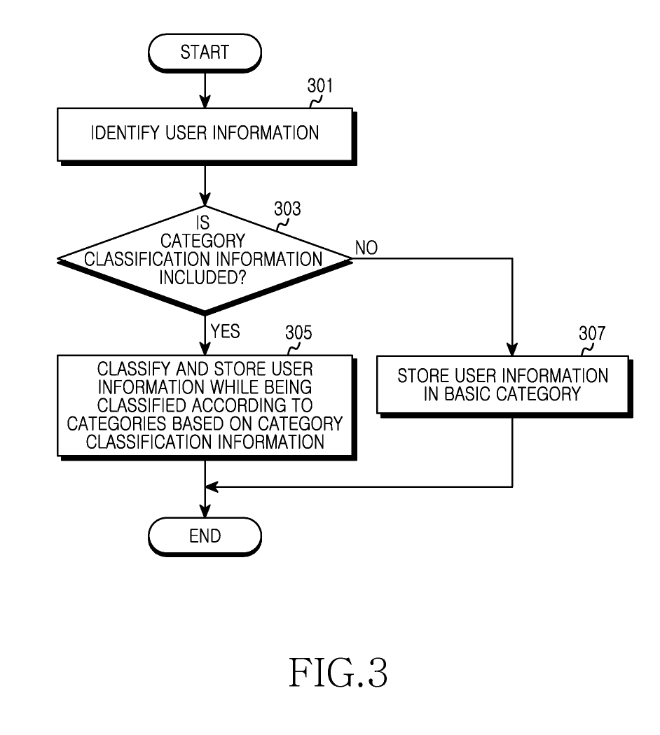

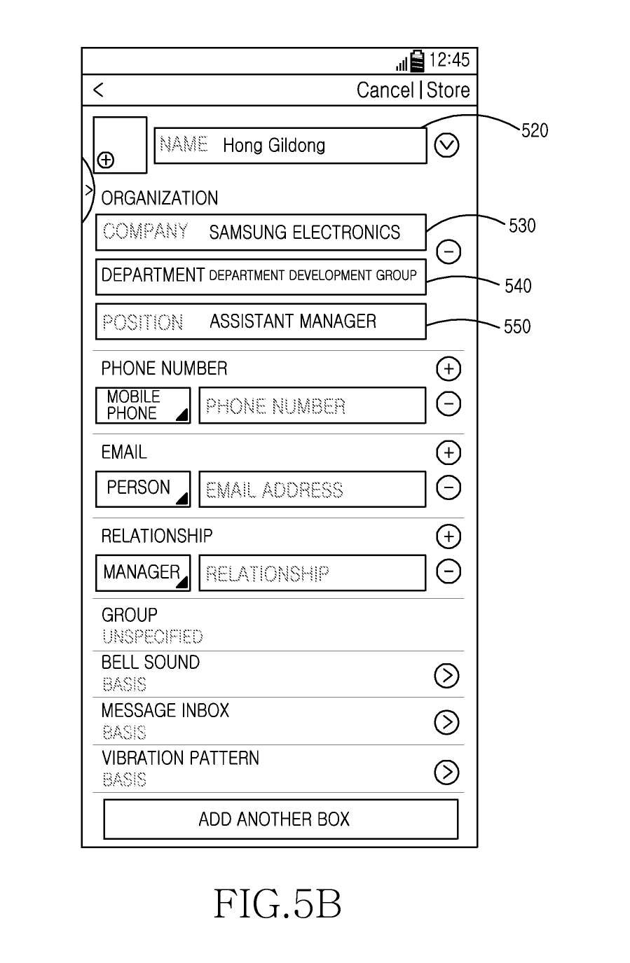

FIG. 3 is a flowchart illustrating operation of a process of classifying user information into a plurality of categories based on category classification information in an electronic device according to one embodiment of the present disclosure. Hereinafter, a description will be given for a process of classifying user information into categories with reference to screens shown in FIGS. 5A and 5B.

Referring now to FIG. 3, at operation 301 the electronic device may identify user information to be stored in its memory. For example, referring to FIG. 5A, the electronic device may identify user information input to a name input field 510 of a contact information registration screen 500 through its input unit. In another example, the electronic device may identify one or more user information included in file such as an address book file.

After identifying the user information, at operation 303 the electronic device may identify whether category classification information is included in the user information. The category classification information may include one or more of a space symbol and other symbols (e.g., “/”, “@”, and “#”).

When the category classification information is included in the user information, at operation 305 the electronic device may divide the user information into categories based on the category classification information and a category setting order and store the divided user information in the memory. For example, when user information of “Hong Gildong/Samsung Electronics/development group/assistant manager” is received through the input unit, the electronic device may divide, as shown in FIG. 5B, the user information to include the “HongGildong” in a basic category (a name category) 520, include the “SamsungElectronics” in a “job” category 530 having a second priority, include the “developmentgroup” in a “department” category 540 having a third priority, and include the “assistantmanager” in a “position” category 550 having a fourth priority according to the category classification information (e.g., “/”) and the category setting order and store the divided user information in the memory.

On the other hand, when the category classification information is not included in the user information, then at operation 307 the electronic device may store the user information in the memory to be included in a basic category.

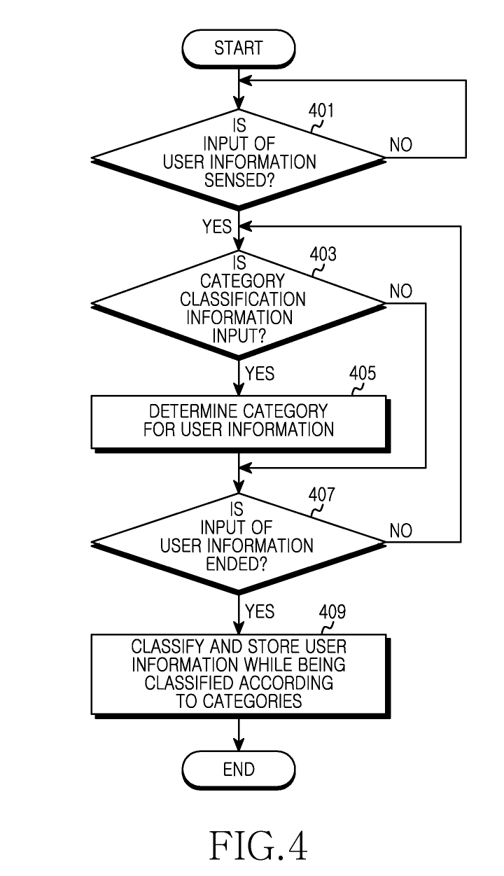

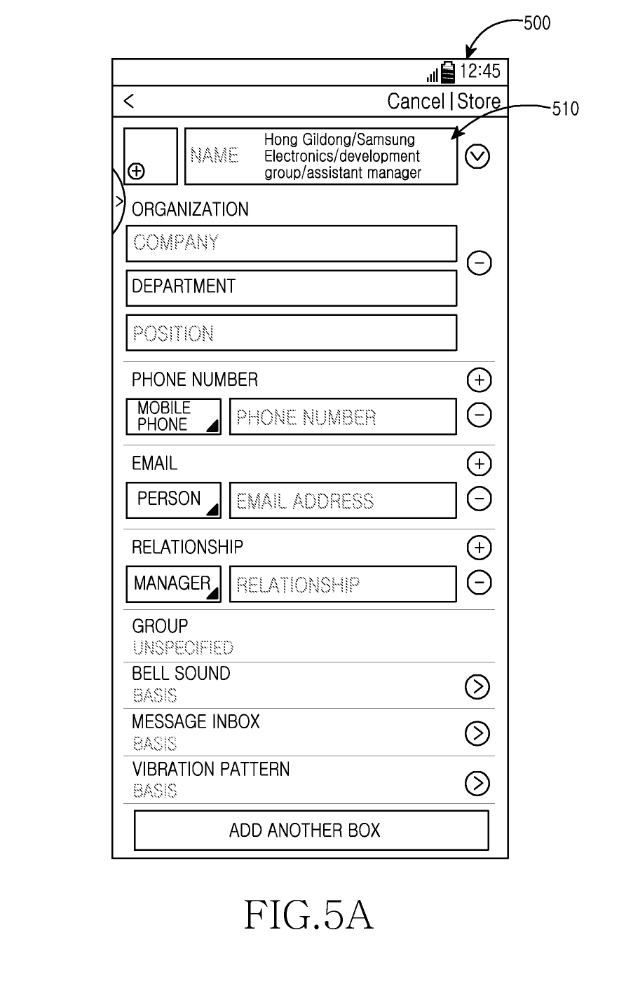

FIG. 4 is a flowchart illustrating an operational process of classifying user information into categories based on category classification information in an electronic device according to another embodiment of the present disclosure.

Hereinafter, a description will be given for a process of classifying user information into categories with reference to screens shown in FIGS. 5A and 5B.

Referring now to FIG. 4, at operation 401 the electronic device may sense whether user information to be stored in its memory is input. For example, referring to FIG. 5A, the electronic device may identify user information input to a name input field 510 of a contact information registration screen 500 through its input unit.

After sensing the input of the user information, at operation 403 the electronic device may identify whether category classification information input. The category classification information may include, for example, one or more of a space symbol and other symbols (e.g., “/”, “@”, and “#”).

When the category classification information is not included in the input user information, at operation 407 the electronic device may identify whether the input of the user information has ended. For example, the electronic device may identify whether an input completion menu is selected based on input information provided through the input unit. In another example, the electronic device may first sense input information through the input unit and then identify whether next input information is sensed within a reference time.

On the other hand, when at operation 403 it is determined that the category classification information is included in the input user information, then at operation 405 the electronic device may determine user information classified by the category classification information based on a category setting order. For example, when input of user information of “HongGildong/” is identified, the electronic device may determine a category of “HongGildong” which is user information classified by the category classification information (“/”) as a basic category (e.g., a name category) 520 which is a first priority.

Thereafter, at operation 407 the electronic device may identify whether the input of the user information has ended. For example, the electronic device may identify whether an input completion menu is selected based on input information provided through the input unit. In another example, the electronic device may first sense input information through the input unit and then identify whether next input information is sensed within a reference time.

When the input of the user information has not ended, then the electronic device may identify whether category classification information is input operation 403.

On the other hand, at operation 409, when the input of the user information is ended, the electronic device may divide and store the user information while being classified according to categories based on category information of the user information. For example, the electronic device may divide and store user information provided through the input unit while being classified according to categories based on category information of user information classified by the category classification information determined at operation 405. In another example, when the category classification information is not input among user information, the electronic device may store user information provided through the input unit in the memory to be included in a basic category.

In the above-described embodiment of the present disclosure, when the category classification information is included in the user information input through the input unit, the electronic device may determine the category of the user information classified by the category classification information based on the category setting order.

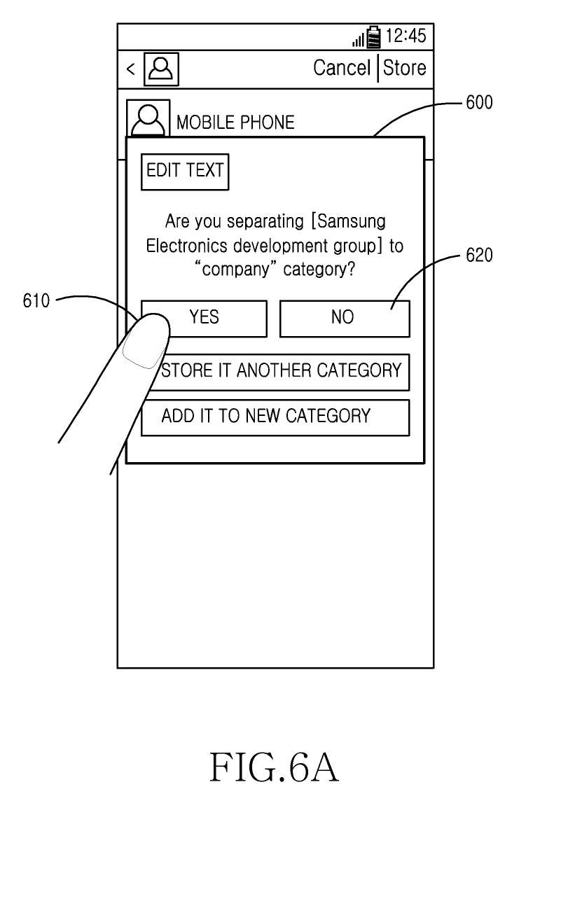

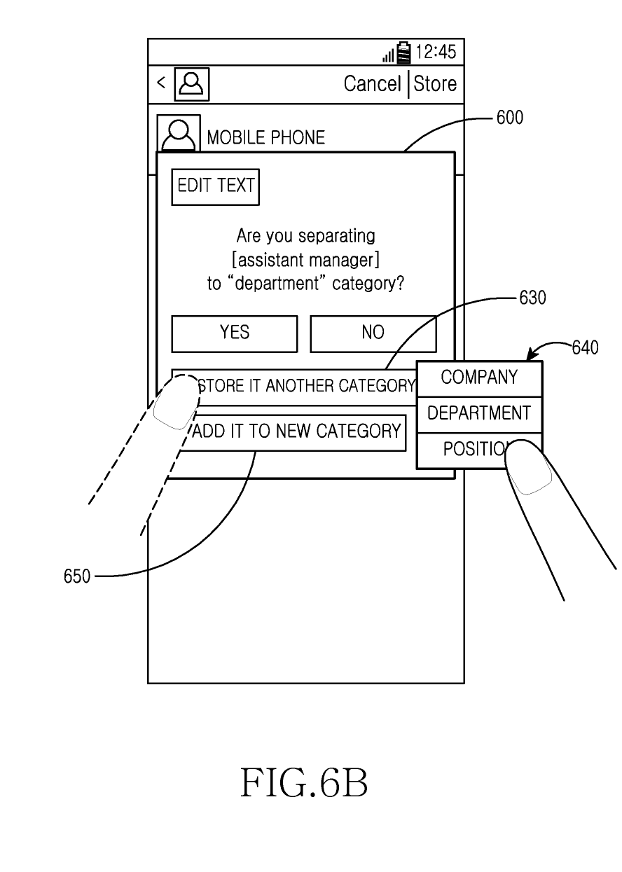

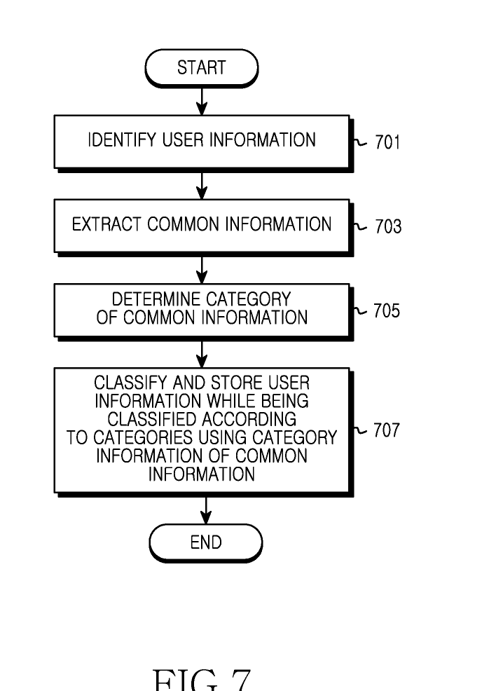

In another embodiment of the present disclosure, when category classification information is included in user information input through the input unit, the electronic device may perform a control operation to allow its user to determine a category of user information classified by the category classification information. For example, when the category classification information is included in the user information input in step 403 of FIG. 4, the electronic device may display, as shown in FIG. 6A, a category setting menu 600 for user information of “SamsungElectronicsdevelopmentgroup” classified by category classification information on its display unit. Herein, a candidate category (e.g., a “company”) for the user information of the “SamsungElectronicsdevelopmentgroup” included in the category setting menu 600 may be determined by a category setting order.

In response to the selection of “YES” 610 on the category setting menu 600 of FIG. 6A being sensed, the electronic device may determine a category for the user information of the “SamsungElectronicsdevelopmentgroup” as a “company” category. On the other hand, when the selection of “NO” 620 on the category setting menu 600 of FIG. 6A is sensed, the electronic device may determine the category for the user information of the “SamsungElectronicsdevelopmentgroup” as a basic category.

In response to the selection of a menu 630 of “storing it in another category” being sensed on the category setting menu 600, the electronic device may display, as shown in FIG. 6B, a list 640 of categories which may be set to the category of the user information of the “SamsungElectronicsdevelopmentgroup” on the display unit. The electronic device may determine a category for the user information of the “SamsungElectronicsdevelopmentgroup” selected by input information provided through the input unit among categories included in the category list 640 of FIG. 6B.

In response to the selection of a menu 650 of “adding it to a new category” being sensed on the category setting menu 600 of FIG. 6A, the electronic device may generate a new category and determine the generated new category as a category of the user information of the “SamsungElectronicsdevelopmentgroup”.

FIG. 7 is a flowchart illustrating an operational process of classifying user information into categories using common information included in the user information in an electronic device according to one embodiment of the present disclosure.

Referring now to FIG. 7, at operation 701 the electronic device may identify user information to be stored in its memory. For example, referring to FIG. 5A, the electronic device may identify user information input to a name input field 510 of a contact information registration screen 500 through its input unit. In another example, the electronic device may identify one or more user information included in an address book file.

Identifying the user information, at operation 703 the electronic device may extract common information included in the user information. For example, the electronic device may extract overlapped common information from user information stored in the memory and the user information identified at operation 701. In another example, the electronic device may extract overlapped common information at operation 703 from a plurality of user information identified at operation 701.

After extracting the common information included in the user information, at operation 705 the electronic device may determine a category of the common information based on a category setting order. For example, the electronic device may divide and store user information by a category shown in Table 1 shown below.

TABLE 1

| | Name | | | | |
|---|---|---|---|---|---|
| | (basic | | | | |
| | category) | company | department | position | . . . |
| 1 | Kim Mi | SamsungElectronics- | | | |
| | | Technologyassetsgroup | | | |
| 2 | Choi | SamsungElectronics- | | | |
| | Minam | Technologyassetsgroup | | | |
| . . . | . . . | . . . | . . . | . . . | . . . |

If user information of “SamsungElectronicsdevelopmentgroup” of “SamsungElectronicsdevelopmentgroupHongGildongassistantmanager” is common information, the electronic device may determine a category of the “SamsungElectronicsdevelopmentgroup” as a “company” category according to a category setting order. Herein, the electronic device may change a category of common information using a category setting menu 600 shown in FIGS. 6A and 6B.

Determining the category of the common information, the electronic device may divide the user information while being classified according to categories using the category information of the common information and store the divided user information in the memory in step 707. Herein, the electronic device may recognize that the other information except for the common information in the user information is included in a basic category.

For example, determining the category of the “SamsungElectronicsdevelopmentgroup” which is common information included in the user information of the “SamsungElectronicsdevelopmentgroupHongGildongassistant manager” as the “job” category, the electronic device may determine a category of the “HongGildongassistantmanager” which is not included in the common information as a basic category.

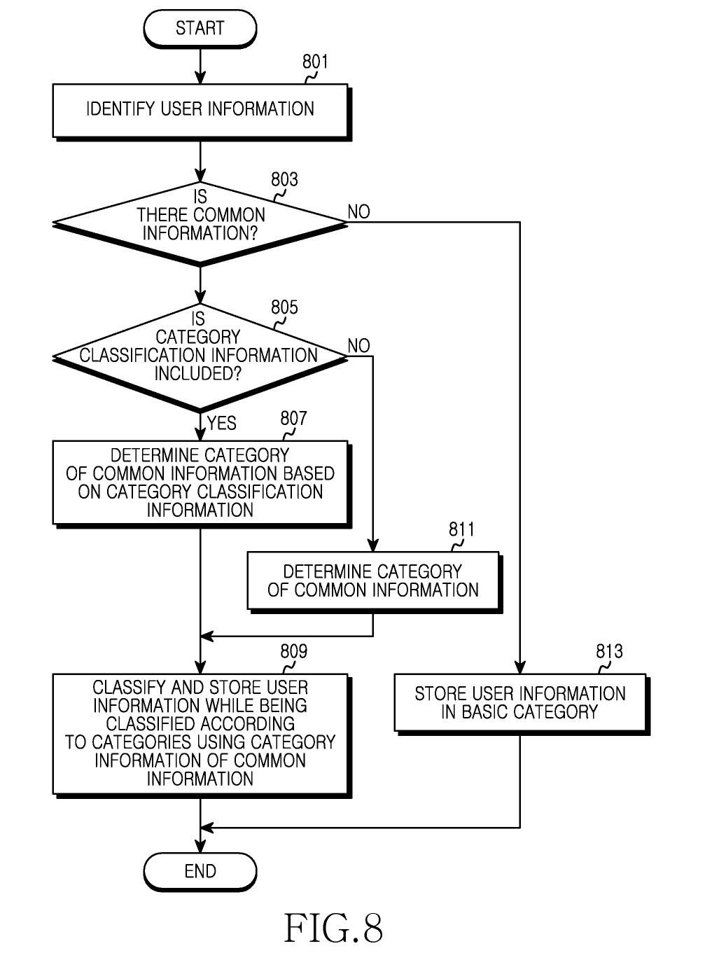

FIG. 8 is a flowchart illustrating a process of classifying user information into categories using common information included in the user information in an electronic device according to another embodiment of the present disclosure.

Referring to FIG. 8, the electronic device may identify user information to be stored in its memory in step 801. For example, referring to FIG. 5A, the electronic device may identify user information input to a name input field 510 of a contact information registration screen 500 through its input unit. In another example, the electronic device may identify one or more user information included in an address book file.

Identifying the user information, the electronic device may identify whether common information is included in the user information in step 803. For example, at operation 801, the electronic device may identify whether there is common information overlapped between user information stored in the memory and the identified user information. In another example, the electronic device may identify whether there is common information overlapped among the plurality of user information identified at operation 801.

When the common information is not included in the user information, at operation 813 the electronic device may store the user information in the memory to be included in a basic category.

On the other hand, at operation 803 when the common information is included in the user information, then at operation 805 the electronic device may identify whether category classification information is included in the common information.

When at operation 805, the category classification information is not included in the common information, the electronic device may determine a category of the common information based on a category setting order by operation 811.

For example, if user information of “SamsungElectronicsdevelopmentgroup” of “SamsungElectronicsdevelopmentgroupHongGildongassistantmanager” is common information, the electronic device may determine a category of the “SamsungElectronicsdevelopmentgroup” as a “job” category according to a category setting order. Herein, the electronic device may change a category of common information using a category setting menu 600 shown in FIGS. 6A and 6B.

When at operation 805 the category classification information is included in the common information, the operation 811 the electronic device may determine categories of common information divided by category classification information operation 807. For example, if user information of “SamsungElectronicsdevelopmentgroupassistantmanager” of “SamsungElectronicsdevelopmentgroupHongGildongassistantmanager” is common information, the electronic device may recognize that the “SamsungElectronicsdevelopmentgroup” and the “assistantmanager” are divided according to category classification information (e.g., a blank). Therefore, the electronic device may determine a category of the “SamsungElectronicsdevelopmentgroup” as a “job” category and determine a category of the “assistantmanager” as a “department” category according to a category setting order. Herein, the electronic device may change a category of common information using the category setting menu 600 shown in FIGS. 6A and 6B.

Determining the category of the common information in operation 807 or 811, the electronic device may divide the user information while being classified according to categories using the category information of the common information and then at operation 809 store the divided user information in the memory. Herein, the electronic device may determine a category of the other information except for the common information in the user information as a basic category.

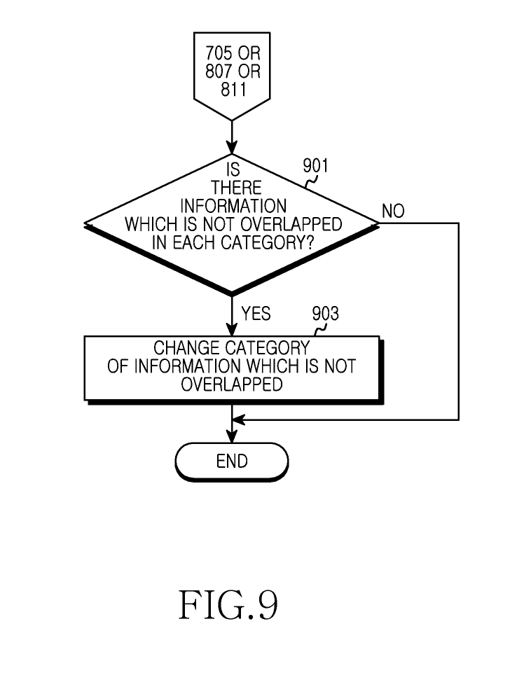

FIG. 9 is a flowchart illustrating an operational process of updating a category of user information using common information of the user information in an electronic device according to one embodiment of the present disclosure.

Referring now to FIGS. 7 to 9, determining the category of the common information in operation 705 of FIG. 7 or operation 807 or 811 of FIG. 8, the electronic device may identify whether there is information which is not overlapped with user information to be newly stored among user information stored in each category. For example, the electronic device may store, as shown in Table 2 shown below, classified user information into categories.

TABLE 2

| | Name | | | | |
|---|---|---|---|---|---|
| | (basic | | | | |
| | category) | Company | department | position | . . . |
| 1 | Hong | SamsungElectronics- | | assistant | |
| | Gildong | Technologyassetsgroup | | manager | |
| 2 | Choi | SamsungElectronics- | | manager | |
| | Minam | Technologyassetsgroup | | | |
| . . . | . . . | . . . | . . . | . . . | . . . |

Newly stored user information of “SamsungElectronicsTechnologyassetsgroupLeeMinyeoassistantmanager”, the electronic device may recognize that the “SamsungElectronics”, the “group”, and the “assistantmanager” between previously stored user information and the user information to be newly stored are overlapped common information. In this case, the electronic device may determine a category of the “SamsungElectronics” of the user information to be newly stored as a “company” category based on a category setting order. Therefore, the electronic device may recognize that the word of the “developmentgroup” in the “SamsungElectronicsdevelopmentgroup” included in the “company” category among previously stored user information is not overlapped by the user information to be newly stored.

When at operation 901 there is the information which is not overlapped in each category, the electronic device may change a category of the information which is not overlapped in each category based on a category setting order in operational 903. For example, as shown in Table 2, when the “developmentgroup” of the “company” category is not overlapped by the user information to be newly stored, the electronic device may set a category of the “developmentgroup” to a “department” category based on a category setting order and predetermined category information of user information.

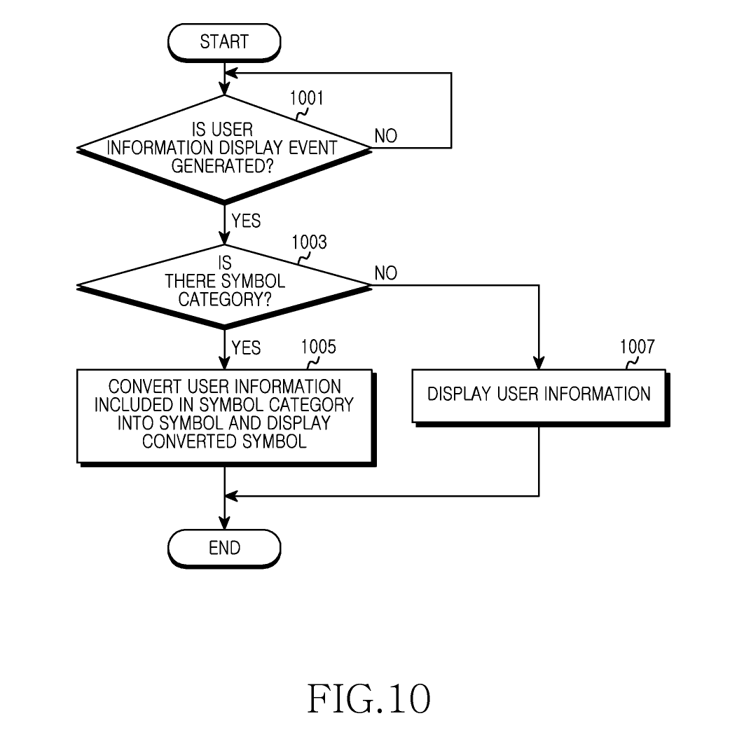

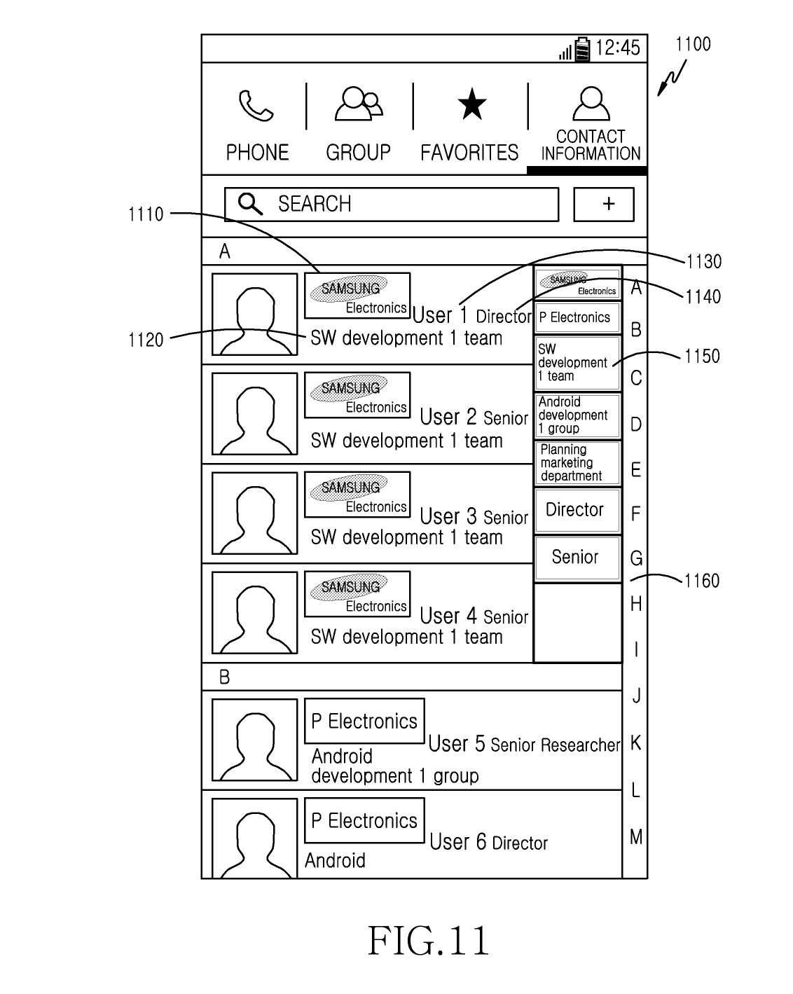

FIG. 10 is a flowchart illustrating an operational process of displaying user information included in some categories as symbols in an electronic device according to one embodiment of the present disclosure. FIG. 11 is a screen illustrating a process of displaying user information included in some categories as symbols in an electronic device according to one embodiment of the present disclosure.

Referring now to FIGS. 10 and 11, at operation 1001 the electronic device may identify whether a user information display event is generated. For example, the electronic device may identify whether an application program for displaying user information, such as a phonebook program, is executed based on input information provided through its input unit.

When at operation 1001 the user information display event is generated, then at 1003 the electronic device may identify whether there is a symbol category among categories for classifying user information. For example, the electronic device may identify whether there are one or more categories which are set to symbol categories based on input information provided through the input unit among categories for classifying user information. Herein, the symbol category may indicate a category which is set to display user information included in a corresponding category as a logo or symbol.

When at operation 1003 there is no symbol category, then at operation 1007 the electronic device may display user information as texts on its display unit.

On the other hand, when at operation 1003 there is the symbol category, then at operation 1005 the electronic device may display user information included in the symbol category as a corresponding logo or symbol. Herein, the electronic device may display user information included in the other categories except for the symbol category as texts. For example, when a “job” category is set to a symbol category, the electronic device may display, as shown in FIG. 11, user information included in the “job” category as a representative logo 1110 and display user information included in the other categories as texts 1120, 1130, and 1140. Herein, the electronic device may display positions and letter sizes for displaying user information included in each category based on importance of categories. In addition, the electronic device may display a first search list 1150 for searching user information based on each of category information and a second search list 1160 for searching user information based on initial sounds of the user information.

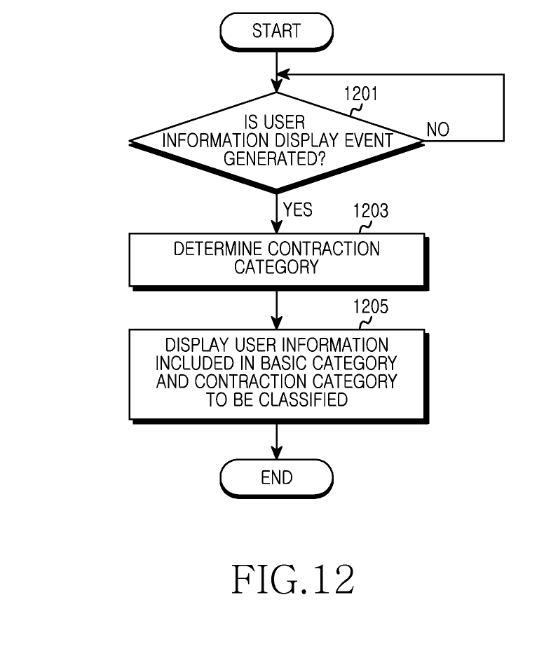

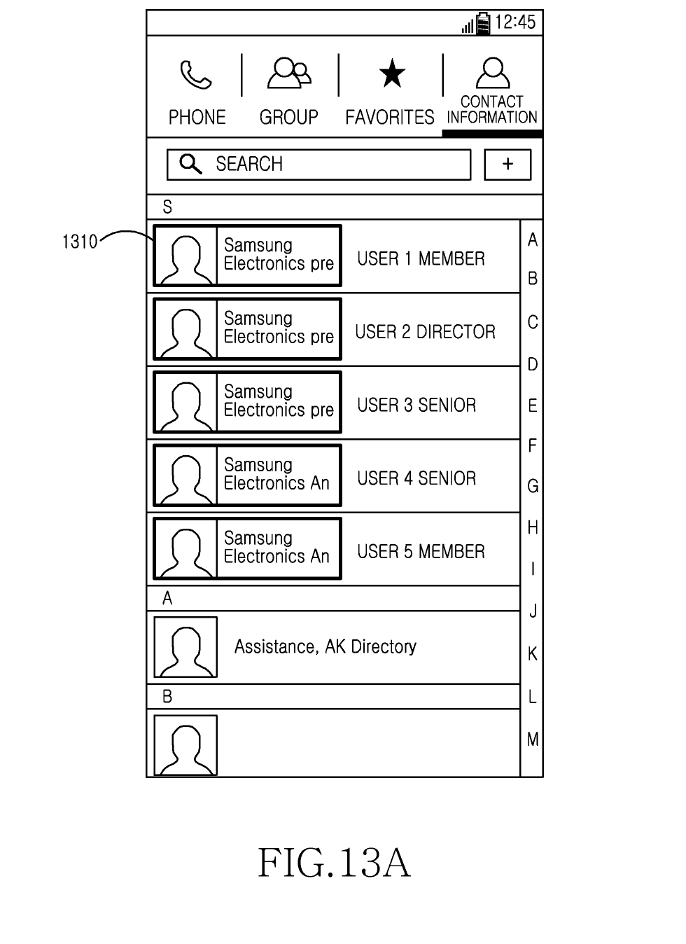

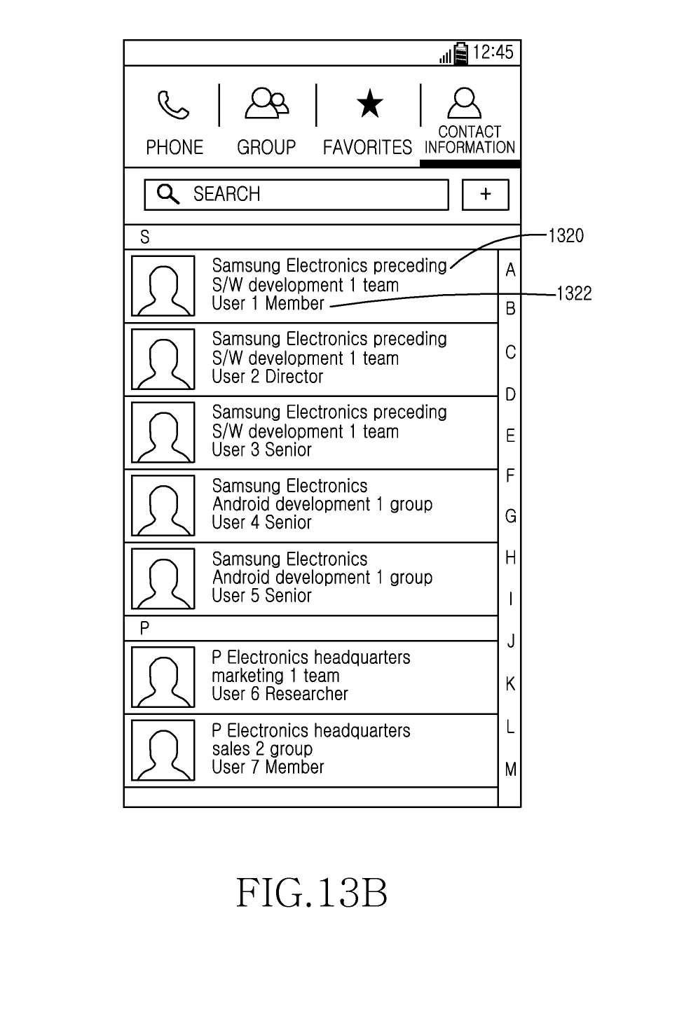

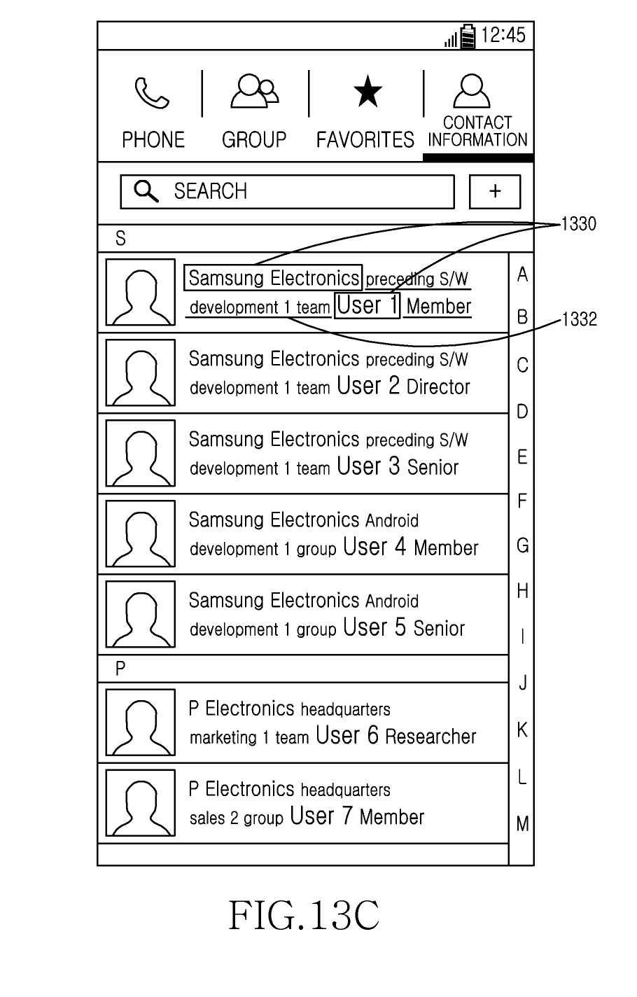

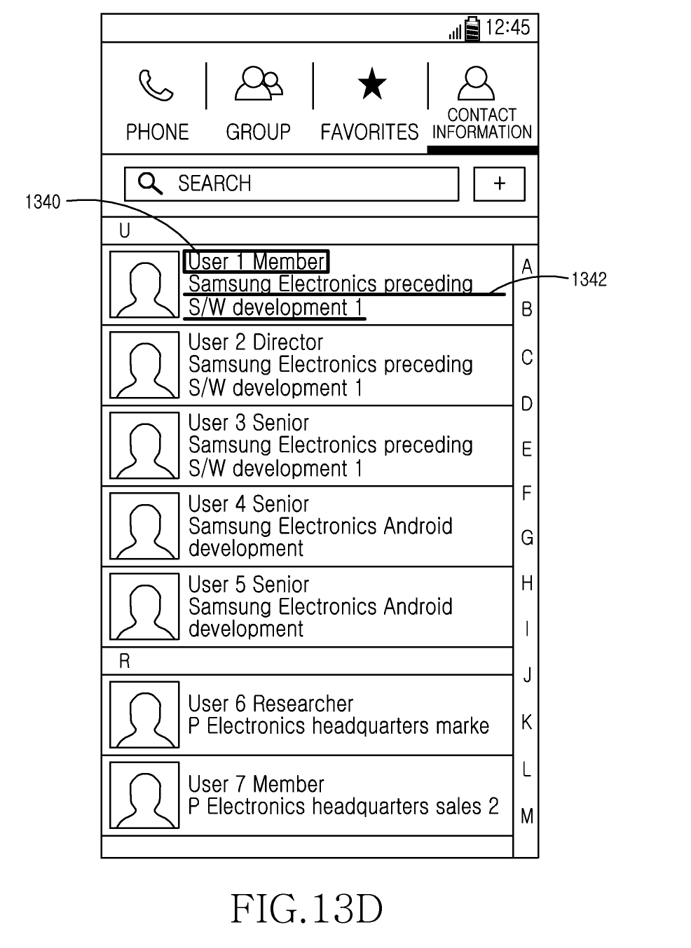

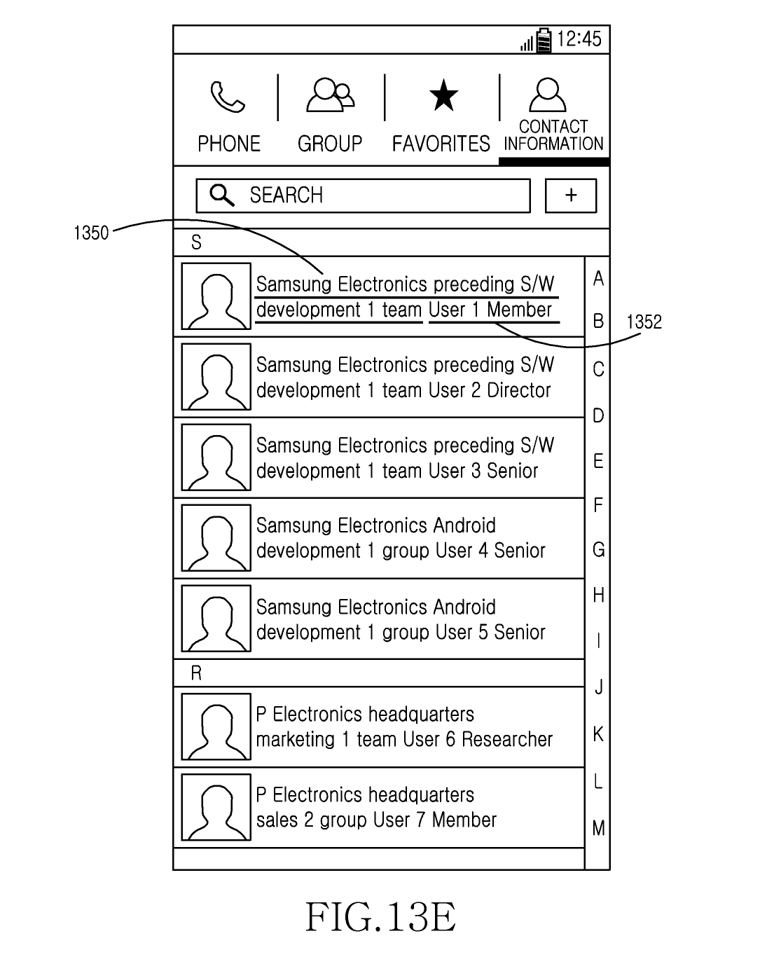

FIG. 12 is a flowchart illustrating a process of contracting and displaying common information included in user information in an electronic device according to one embodiment of the present disclosure. FIGS. 13A to 13E are screens illustrating a process of contracting and displaying common information included in user information in an electronic device according to one embodiment of the present disclosure.

Referring now to FIGS. 12 and 13A to 13E, at operation 1201 the electronic device may identify whether a user information display event is generated. For example, the electronic device may identify whether an application program for displaying user information, such as a phonebook program, is executed based on input information provided through its input unit.

When at operation 1201 the user information display event is generated, then at operation 1203 the electronic device may determine a contraction category among categories for classifying user information. For example, the electronic device may identify one or more categories which are set to contraction categories based on input information provided through the input unit among categories for classifying user information. In another example, the electronic device may set a category including common information among user information stored in its memory to a contraction category. Herein, the contraction category may indicate a category set to contract and display user information included in a corresponding category to highlight user information included in other categories.

Determining the contraction category, the electronic device may display user information based on information about the contraction category in operation 1205.

For example, referring to FIG. 13A, the electronic device may display user information 1310 included in a “job” category and a “department” category which are determined as contraction categories on a display region of a reference size by a slide type. Herein, the electronic device may display user information included in the other categories as texts on a front or rear portion of a display region for displaying the contraction categories.

In another example, referring to FIG. 13B, the electronic device may display user information included in a “job” category and a “department” category which are determined as contraction categories as texts 1320 of a first size on a first line and display user information included in the other categories as texts 1322 of a second size on a second line. Herein, the texts of the first size may be set to be larger than that of the second size.

In another example, referring to FIG. 13C, the electronic device may display user information included in a “job” category and a “position” category which are determined as contraction categories as texts 1330 of a first size and display user information included in the other categories as texts 1332 of a second size. Herein, the texts of the first size may be set to be larger than that of the second size.

In the above-described embodiment of the present disclosure, the electronic device may display or contract and display one or more categories as symbols to allow the user to recognize user information stored in the memory easily.

In yet another embodiment of the present disclosure, the electronic device may change a display order of user information included in a category based on importance to each category. For example, referring to FIG. 13D, the electronic device may successively display user information 1340 included in a “name” category and a “position” category which are determined as importance categories. Herein, the electronic device may contract and display user information 1342 included in the other categories which are not set to importance categories based on one or more types of FIGS. 13A to 13C.

Also, in another example, the electronic device may differently display a display color of user information included in a category based on importance to each category. For example, referring to FIG. 13E, the electronic device may display user information included in a “name” category and a “position” category which are determined as importance categories by a first color 1352 and display user information included in the other categories by a second color 1350. Herein, the electronic device may contract and display the user information included in the other categories based on one or more types of FIGS. 13A to 13C.

Methods according to claims of the present disclosure and/or embodiments described in the specification of the present disclosure may be implemented as hardware, software configured to operate hardware, or combinational type of the hardware and machine executable code.

When the method is implemented by the software that is loaded into hardware, a computer-readable storage medium for storing one or more programs (software modules) may be provided. The one or more programs stored in the computer-readable storage medium are configured for being executed by one or more processors (control unit, controller, etc.) in an electronic device. The one or more programs include instructions for allowing an electronic device to execute the methods according to the claims of the present disclosure and/or the embodiments described in the specification of the present disclosure.

These programs (software modules, software) may be stored in a Random Access Memory (RAM), a non-volatile memory including a flash memory, a Read Only Memory (ROM), an Electrically Erasable Programmable ROM (EEPROM), a magnetic disc storage device, a Compact Disc-ROM (CD-ROM), a Digital Versatile Disc (DVD) or an optical storage device of a different type, and a magnetic cassette. Or, the programs may be stored in a memory configured by combination of some or all of them. Also, the configured memory may include a plurality of memories.

Also, the programs may stored in an attachable storage device which may access an electronic device through each of communication networks such as the Internet, an intranet, a Local Area Network (LAN), a Wide LAN (WLAN), and a Storage Area Network (SAN) or a communication network configured by combination of them. This storage device may connect to the electronic device through an external port.

The apparatuses and methods of the disclosure can be implemented in hardware, and in part as firmware or as software or computer code in conjunction with hardware that is stored on a non-transitory machine readable medium such as a CD ROM, a RAM, a floppy disk, a hard disk, or a magneto-optical disk, or computer code downloaded over a network originally stored on a remote recording medium or a non-transitory machine readable medium and stored on a local non-transitory recording medium for execution by hardware such as a processor, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” “controller”, or “control unit” constitute hardware in the claimed disclosure that contain circuitry that is configured for operation. Under the broadest reasonable interpretation, the appended claims constitute statutory subject matter in compliance with 35 U.S.C. §101.

The definition of the terms “unit” or “module” as referred to herein are to be understood as constituting hardware circuitry such as a CCD, CMOS, a processor or microprocessor configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and do not constitute software per se.

Also, a separate storage device on a communication network may connect to a portable electronic device.

As described above, the electronic device may allow the user to input user information easily by extracting common information included in the user information and classifying and storing the classified user information into categories.

Also, the electronic device may display user information stored in the memory efficiently by displaying information included in some categories as symbols or contracting and displaying common information.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. A method in an electronic device, the method comprising:
detecting plurality of user information;
extracting common information from the detected plurality of user information; and
storing the common information of the plurality of user information in a first category and storing another information except the common information among the plurality of user information in a second category.

2. The method of claim 1, wherein the user information includes one or more of phone numbers, names, jobs, departments, positions, photos, emails, other phone numbers, addresses, anniversaries, and groups.

3. The method of claim 1, wherein the detecting the plurality of user information comprises identifying one or more user information to be stored in a memory and one or more user information already stored in the memory.

4. The method of claim 1, wherein the detecting the plurality of user information comprises identifying the plurality of user information to be stored in a memory.

5. The method of claim 1, further comprising determining a category of the common information after extracting the common information,
wherein the storing of the common information in the second category comprises storing the common information of the user information in the determined category.

6. The method of claim 1, further comprising:
after extracting the common information, determining whether the common information includes category division information;
dividing the common information into a plurality of common information based on the category division information in response to determining the common information includes the category division information; and
determining a category corresponding to each of the plurality of common information,
wherein the storing of the common information in the second category comprises storing the each of the plurality of common information in the determined category.

7. The method of claim 1, further comprising displaying user information from one or more categories as symbols among one or more user information which are divided into a plurality of categories and are stored in a memory, when a display event is generated.

8. The method of claim 1, further comprising:
contracting user information from one or more categories among one or more user information which are divided into a plurality of categories and are stored in the memory, when a display event is generated; and
displaying the contracted user information.

9. The method of claim 1, further comprising:
identifying one or more designated importance categories from among one or more user information which are divided into a plurality of categories and are stored in a memory, when a display event is generated; and
changing and displaying a position of user information included in one or more designated importance categories.

10. The method of claim 1, further comprising:
identifying one or more designated importance categories among one or more user information which are divided into a plurality of categories and are stored in a memory, when a display event is generated; and
differently displaying a color of user information included in the one or designated more importance categories and other categories.

11. An electronic device comprising:
a memory; and
a processor comprising circuitry configured for operation,
wherein the processor is configured to detect a plurality of user information, to extract common information from the plurality of user information, and to store the common information of the plurality of user information in a first category and to store the another information except the common information among the plurality of user information in a second category.

12. The electronic device of claim 11, wherein the user information includes one or more of phone numbers, names, jobs, departments, positions, photos, emails, other phone numbers, addresses, anniversaries, and groups.

13. The electronic device of claim 11, wherein the processor is configured to extract the common information from one or more user information to be stored in the memory and one or more user information already stored in the memory.

14. The electronic device of claim 11, wherein the processor is configured to extract the common information from the plurality of user information to be stored in the memory.

15. The electronic device of claim 11, wherein the processor is configured to determine a category of the common information after extracting the common information, and to store the common information of the plurality of user information in the determined category.

16. The electronic device of claim 11, wherein the processor is configured to divide the common information into a plurality of common information based on category division information, when the common information includes the category division information, to determine a category corresponding to each of the plurality of common information, and to store the each of the plurality of common information in the determined category.

17. The electronic device of claim 11, further comprising a display unit,
wherein the processor is configured to display user information included in one or more categories as symbols among one or more user information which are divided into a plurality of categories and are stored in the memory on the display unit, when a display event is generated.

18. The electronic device of claim 11, further comprising a display unit,
wherein the processor is configured to contract user information included in one or more categories among one or more user information which are divided into a plurality of categories and are stored in the memory and displays the contracted user information on the display unit, when a display event is generated.

19. The electronic device of claim 11, further comprising a display unit,
wherein the processor is configured to change a position of user information included in one or more categories having designated importance among one or more user information which are divided into a plurality of categories and are stored in the memory and displays the changed user information on the display unit, when a display event is generated.

20. The electronic device of claim 11, further comprising a display unit,
wherein the processor is configured to differently display a color of user information included in the one or more categories having designated importance and other categories among one or more user information which are divided into a plurality of categories and are stored in the memory on the display unit, when a display event is generated.
